(19) United States
(12) Patent Application Publication
(10) Pub. No.: US 2023/0047234 A1
(43) Pub. Date: Feb. 16, 2023

(54) METHOD FOR OPERATING A RADAR SENSOR IN A MOTOR VEHICLE, AND MOTOR VEHICLE

(71) Applicant: Audi AG, Ingolstadt (DE)

(72) Inventors: Niels KOCH, Ingolstadt (DE); Matthias HINTERDING, Ingolstadt (DE)

(73) Assignee: Audi AG, Ingolstadt (DE)

(21) Appl. No.: 17/760,155

(22) PCT Filed: Jan. 27, 2021
(86) PCT No.: PCT/EP2021/051786

§ 371 Date: Aug. 4, 2022

(30) Foreign Application Priority Data
Feb. 6, 2020 (DE) 10 2020 103 101.7

(51) Int. Cl. G01S 13/931; G01K 3/00

(52) U.S. Cl. CPC G01S 13/931; G01K 3/005

(57) ABSTRACT

The present disclosure relates to a method for operating a radar sensor, in particular a long range radar sensor, in a motor vehicle. The radar sensor has a detection range defined by an area in front of the motor vehicle or an area behind the motor vehicle. The radar sensor is operated with a transmitting power that determines the detection range of the radar sensor, and radar data of the radar sensor is evaluated within the radar sensor to detect objects in the detection range. The transmitting power of the radar sensor is increased from a first transmitting power value to a second transmitting power value when a switching criterion is met, indicating that no objects satisfying a relevance criterion have been detected by the radar sensor.

### TECHNICAL FIELD

The present disclosure relates to a method for operating a radar sensor, in particular a long-range radar sensor in a motor vehicle, wherein the radar sensor has a detection range directed towards the area in front of or the space behind the motor vehicle, the radar sensor is operated with a transmitting power determining a range of the radar sensor, and the radar data of the radar sensor is evaluated, in particular within the radar sensor itself, to detect objects in the detection range. The present disclosure also relates to a motor vehicle.

### BRIEF SUMMARY

The use of radar sensors in modern motor vehicles is common nowadays. Different types of radar sensors are known in order to be able to detect the surroundings of the motor vehicle. A short range radar (SRR) has a maximum measuring range of up to 30 m, a medium range radar (MRR) has a maximum range of up to 150 m, and a long range radar (LRR) has a maximum range of up to 250 m. Long-range radars (LRR) are often used to monitor the area in front of and the space behind the motor vehicle at greater distances. The radar data recorded by radar sensors of a motor vehicle are used by various vehicle functions of different vehicle systems, in particular driver assistance systems. For example, it is known to use radar data from a long-range radar sensor in vehicle functions of a longitudinal adaptive distance control system (ACC system), an overtaking assistant, a lane change assistant, and also for safety systems, for example maneuvering systems. In addition, radar data, also from long-range radar sensors, are usually used, at least partially, for automatic guidance of the motor vehicle.

Modern radar sensors which are installed in motor vehicles for monitoring the surroundings, mostly use, at least in part, semiconductor technologies, in which case transmission chips, in particular so-called MMICs, are usually used as transmission units for transmitting the radar signals. Depending on the transmitting power used, such a transmission chip can heat up.

In this context, it is known in the prior art to operate radar sensors in motor vehicles with a constant transmitting power in order not to thermally damage or destroy the transmission chip, in particular the MMIC. The transmitting power is set to a transmitting power value such that, under all temperature conditions, for example in the range from −40° C. to +80° C., the thermal load on the transmission chip can be represented non-destructively and usually with reserve. This results in a reduction in the transmitting power actually used compared to the fundamentally possible transmitting power, in order to allow the radar sensor to function permanently under the general thermal conditions. For example, long-range radar sensors (LRR) are now usually set to 10 dBm transmitting power, although the transmission chip could emit 13 dBm (20 mW) or modern transmission chips even 14 dBm (30 mW) transmitting power.

However, due to the reduction in transmitting power with regard to the ongoing operation of the radar sensor, the maximum range in which the radar sensor can detect objects is also reduced. This also goes hand in hand with a reduced detection probability for small objects, such as motorcycles. However, it should be noted that with increasing regulation of the detection of objects, there are requirements that medium-range (MRR) and long-range (LRR) radar sensors in particular must meet. For example, it may be stipulated that motorcyclists must be recognized under all circumstances at a distance of 55 m (see, for example, the current version of the steering standard ECT79 at the time of the application).

For the detection of objects in the vicinity of a vehicle in a radar sensor system, DE 10 2004 017 720 A1 proposes adaptively controlling the transmitting power of the radar signal as a function of the actual distance from a nearest object, taking into account a functional parameter provided for a desired radar function. It can be provided that the closer the object comes, the lower the transmitting power is, in order to avoid overrides. Such an override is to be expected in particular if measurements are to be taken at close range, for example at a distance of only a few meters, so that the teaching there applies in particular to short range radars (SRR), in particular also so-called near-field radars (NFR), which should measure in ranges of one meter or less.

DE 10 2007 046 648 A1 relates to a radar sensor for detecting the traffic surroundings in motor vehicles. The radar sensor has an adjustable transmission and/or reception amplifier and an adjustment device for adjusting the transmission and/or reception gain, with the traffic surroundings being continuously evaluated by an evaluation device and the adjustment device being acted on depending on the current evaluation, in order to reduce the number of interfering radar echoes from irrelevant objects, in particular in city traffic. To this end, complicated beamforming approaches and complex modifications of the antenna arrays are described.

DE 103 47 214 A1 relates to a radar system with at least one detector for special weather conditions. The transmitting power of the radar system is controlled as a function of the particular weather condition detected by the at least one detector, with power amplification being intended to be carried out, for example, when visibility is poor. However, this would increase the clutter caused by raindrops and/or snowflakes, for example.

### BRIEF DESCRIPTION OF THE DRAWINGS/FIGURES

FIG. 1 shows a flowchart of an embodiment of the method according to the present disclosure

FIG. 2 shows a first driving situation according to an embodiment of the present disclosure.

FIG. 3 shows a second driving situation according to an embodiment of the present disclosure.

FIG. 4 shows a motor vehicle according to an embodiment of the present disclosure.

FIG. 5 shows the functional structure of a radar sensor according to an embodiment of the present disclosure.

### DETAILED DESCRIPTION

The present disclosure is therefore based on the object of allowing objects to be detected as early as possible by a radar sensor in the simplest possible manner, in particular with sustained, long-term operation.

For solving this problem, the present disclosure provides in a method of the initially described type that the switching power of the radar sensor is increased from a first transmitting power value to a second transmitting power value when a switching criterion is met indicating that no objects, in particular no objects satisfying a relevance criterion, have been detected by the radar sensor.

The present disclosure is based on the finding that, when typical trips with a motor vehicle that has a long-range front or rear radar sensor are examined, there is at least one relevant object in the detection range of the radar sensor for most of the time; to a lesser extent no (relevant) object can be detected in the detection range. It is therefore proposed that, if no object, in particular no relevant object, is detected in the detection range, the transmitting power of the radar sensor is increased in order to increase the detection range and thus also make smaller objects, for example motorcyclists, detectable earlier. Instead of setting the transmitting power to an average continuous power, it is proposed according to the present disclosure to strive for dynamic transmitting power control.

The conservative power setting to thermally protect the transmission unit, in particular the transmission chip, of the radar sensor reduces the transmitting power and thus the range and the ability to detect smaller objects. It is often the case that a high transmitting power is not required anyway, since objects are sufficiently close to be detected with a low transmitting power. The present disclosure now makes it possible to increase the transmitting power of the radar sensor on roads with little traffic and in areas with few (relevant) objects in order to obtain early detection if a (relevant) object does appear.

If an object appears again, in particular a relevant object, which therefore fulfills the relevance criterion, the transmitting power can be correspondingly reduced again. In the context of the present disclosure, it can therefore be said in general that the transmitting power is reduced again from the second transmitting power value to the first transmitting power value when a reduction criterion is met, wherein at least a first of the at least one reduction criterion checks whether an object, in particular one satisfying the relevance criterion, is detected by the radar sensor. At the same time, however, temperature monitoring can expediently also take place, for example by means of a temperature sensor in or on the radar sensor. Accordingly, an expedient development of the present disclosure provides that at least a second of the at least one reduction criterion checks whether a temperature of the radar sensor, in particular a transmission unit of the radar sensor, exceeds a first threshold value and/or checks whether a thermal reserve value carried over time due to a measured temperature falls below a second threshold value.

If no (relevant) object is detected and there are sufficient thermal reserves, the transmitting power can be increased to the second transmitting power value, which can correspond in particular to the maximum performance of a transmission chip as a transmission unit, until an object is detected or a maximum temperature (first threshold value) is reached or the thermal reserves are considered to be too low (second threshold value).

A particularly advantageous embodiment of the present disclosure provides that, when the first reduction criterion is met, the transmitting power is reduced from the second transmitting power value to the first transmitting power value continuously or in steps, in particular depending on a distance and/or a relative speed of the detected object, such that the object is still detected by the radar sensor despite the reduction of the transmitting power. In other words, when a (relevant) object is detected, the transmitting power can be reduced again in steps, this being done with particular advantage in such a way that the resulting range is equal to or greater than the distance by a tolerance value. In other words, it is ensured in this way that the object continues to be recognized and can therefore be tracked (known as “tracking”). At the same time, however, the thermal load on the transmission unit, in particular on the transmission chip, is reduced again.

It should also be pointed out in general at this point that evaluated radar data used only to evaluate the switching criterion can advantageously also be supplied by a tracking algorithm within the radar sensor, i.e. in particular by a tracking unit of the control device of the radar sensor. For example, a tracking unit that implements a tracking algorithm can supply the information as to whether or not a (relevant) object is being tracked. In the second case, it can be assumed that a (relevant) detected object is not present. Such tracking algorithms are now usually implemented within the radar sensors themselves, which can also apply to the dynamic transmitting power control described here, for which the control device of the radar sensor can have a corresponding transmitting power unit or a corresponding transmitting power algorithm.

It should be emphasized again in this context that the present disclosure offers a variant of dynamic transmitting power control that is particularly easy to implement, which can be implemented using existing means (temperature sensor, tracking algorithm) and can be implemented, for example, by only a small control loop with a few lines of code in a transmitting power algorithm. In other words, use is made of the fact that the required information, for example whether a tracking algorithm is tracking a relevant object, as well as information regarding the thermal load of a temperature sensor which is in particular assigned to or provided in the radar sensor, is already available and only needs to be queried in order to implement a transmitting power control in an easy way without the need for complex beamforming and antenna pattern control approaches. Despite this simple feasibility, an earlier detection of (relevant) objects is possible, since, when no (relevant) object is detected, the transmitting power is increased, even if only for a short time, so that improved detection and thus improved safety on the road is given. In other words, an improvement in early object detection can be achieved through the dynamic design of the transmitting power in conjunction with the detection of (relevant) objects and temperature information in a simple control loop.

In this context, it should also be pointed out that the thermal load on transmission units, in particular transmission chips, in radar sensors has hitherto been adjusted to the maximum ambient temperature of 80 to 85° C. in connection with the continuous transmitting power. In the rarest of cases, however, 80° C. are reached, since even in deserts, temperatures of 50° C. and more usually only occur for a short time. The majority of the continents are in the moderate temperature range, although the temperatures would also be far from a limit of 30° C. for long periods of the year. Therefore, a short-term increase in transmitting power until another (relevant) object appears in the detection range of the radar sensor turns out to be feasible.

The evaluation of the switching criterion and the at least one reduction criterion preferably relates to relevant objects, it being possible in particular for the relevance criterion to be selected in such a way that it is fulfilled for objects that are classified in such a way that they are to be taken into account by the functions using radar data of the radar sensor. The classification of objects from radar data is already widely known in the prior art in order to keep the number of objects actually to be evaluated by the vehicle functions as low as possible and, for example, to exclude peripheral development objects and the like as far as possible. Accordingly, objects can be classified as belonging to a relevance class. Such a relevance class can contain, for example, dynamic objects, and therefore other road users. Vehicle functions that use radar data from radar sensors can include, for example, ACC functions, overtaking assistance functions, lane change assistance functions, safety functions (e.g. maneuvering assistance functions) and functions for at least partially automatic guidance of the motor vehicle. The relevance criterion can also take into account whether the corresponding vehicle function is currently active at all.

Preferably, the second transmitting power value can be increased by 20 to 50%, in particular by 30%, compared to the first transmitting power value, and/or the range given by the second transmitting power value can be increased by 30 to 70%, in particular 50%, compared to the range given by the first transmitting power value. For example, increasing the transmitting power from 10 dBm continuous power to 13 dBm short-term power can already ensure a 50% increase in range and thus early detection of (relevant) objects. It should be pointed out that legal regulations, which for example in Germany provide for an effective isotropic power output of a maximum of 55 dBm, are usually unproblematic, although these represent an addition of the transmitting power in dBm and of the antenna gain in dBi. In the case of long-range radar sensors, the transmitting power is typically in the range of 10 to 14 dBm and the antenna gain is typically 15 to 21 dBi, so that even with a second transmitting power value using the maximum possible transmitting power, it functions far away from such a limit.

As already explained, a radar sensor with a transmission unit designed as a transmission chip, in particular an MIMIC, is preferably used as the radar sensor. In this case, it can be provided with particular advantage that a temperature sensor integrated in the transmission chip is used to measure a temperature of the radar sensor, in this case specifically a temperature of the transmission chip. While it is possible in principle within the scope of the present disclosure to use measured temperature values of the outside and/or ambient temperature for temperature monitoring, it is preferred according to the present disclosure to use a temperature sensor in the vicinity of the transmitter chip or preferably integrated there in order to monitor the thermal load on the transmission chip as realistically as possible.

In addition to the method, the present disclosure also relates to a motor vehicle, having a particularly long-range radar sensor, wherein the radar sensor has a detection range directed towards the area in front of or the space behind the motor vehicle, the radar sensor is operated with a transmitting power determining a range of the radar sensor, and also has a control device which is designed to carry out the method according to the present disclosure. All the configurations and comments regarding the method according to the present disclosure apply analogously to the motor vehicle according to the present disclosure, such that the advantages already mentioned can also be obtained with this motor vehicle.

Specifically, the control device can have, for example, a transmitting power unit for carrying out the method according to the present disclosure, which, for example, can directly receive data from a tracking unit of the control device just like data from a temperature sensor and/or a temperature monitoring unit.

Further advantages and details of the present disclosure will become apparent from the embodiments described below and with reference to the drawings.

FIG. 1 shows a flow chart of an embodiment of the method according to the present disclosure for operating a long-range radar sensor (LRR) in a motor vehicle. The radar sensor is directed towards the area in front of or the space behind the motor vehicle. Due to at least one vehicle function of the motor vehicle that is active over longer periods of time, the radar sensor must be operated continuously so that it can supply radar data for the vehicle function. In this case, the radar sensor itself is already designed for a first evaluation of the radar data, in that detected objects are classified in particular on the basis of a relevance criterion that filters out objects that are not relevant for the at least one vehicle function, and tracking takes place using a tracking algorithm in a tracking unit, with the tracking being limited to relevant objects. Relevant objects can include other road users and/or obstacles on the road, for example.

In normal operation of the radar sensor, step S1, the radar sensor is operated with a transmitting power according to a first transmitting power value. The normal operation of the radar sensor relates to the situation, according to an underlying finding, which is significantly more frequent, in which at least one relevant object is detected and tracked. The first transmitting power value is selected in such a way that overheating of the transmission chip used as the transmission unit in the radar sensor, in this case an MMIC, is prevented. A specific first range and a specific detection capability with regard to smaller objects, for example motorcyclists, result from the first transmitting power value.

In a step S2, it is checked whether a switching criterion is fulfilled. In the present case, the switching criterion is fulfilled when no relevant objects are detected, meaning that no relevant objects are tracked in the tracking unit. If the switching criterion is not fulfilled, the process continues with step S1 using the first transmitting power value, while, if the switching criterion is met, the system branches to step S3, in which the transmitting power is increased to a second transmitting power value that is higher than the first transmitting power value. In one example, the transmitting power can then be increased to a maximum performance of the transmission chip, for example. With an increase from 10 dBm as the first transmitting power value to 13 dBm as the second transmitting power value, a second range that is 50% higher than the first range can be achieved. The transmitting power increased in this way not only increases the range, but also correspondingly the detection capability for smaller objects, so that overall relevant objects can be detected earlier. In other words, the easily ascertainable and implementable increase in the transmitting power ensures the earliest possible detection of newly occurring relevant objects when there is currently no relevant object in the detection range.

In a step S4, a second reduction criterion is checked, which is used to determine whether there is a risk of the transmission chip overheating, for example if the second transmitting power value was needed longer than expected or the like. For this purpose, it can be checked whether a measured temperature value of a temperature sensor exceeds a first threshold value and/or, if a heat balance is kept, whether a thermal reserve falls below a second threshold value. If the second reduction criterion is fulfilled, the transmitting power is reduced again, at least temporarily, to the first transmitting power value, step S1.

Otherwise, a first reduction criterion is checked in a step S5, which monitors whether a new relevant object was detected by the radar sensor at an early stage due to the increased transmitting power. If this is not the case, the process continues with step S3, but if this is the case, a branch is made to a step S6. In step S6, starting from the second transmitting power value, the transmitting power is reduced in steps (or alternatively also continuously) back to the first transmitting power value, with step S1 continuing again when this value is reached. The stepwise (or alternatively continuous) reduction takes place as a function of the distance and/or the relative speed of the detected object in such a way that it is ensured that this object can also be further detected and thus tracked. In other words, a transmitting power is selected in such a way that the range allows continuous detection of the object.

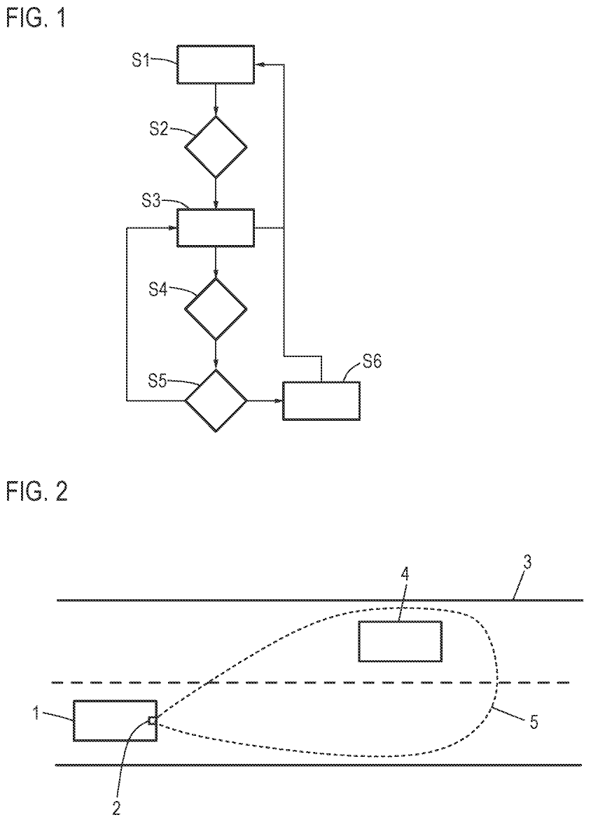

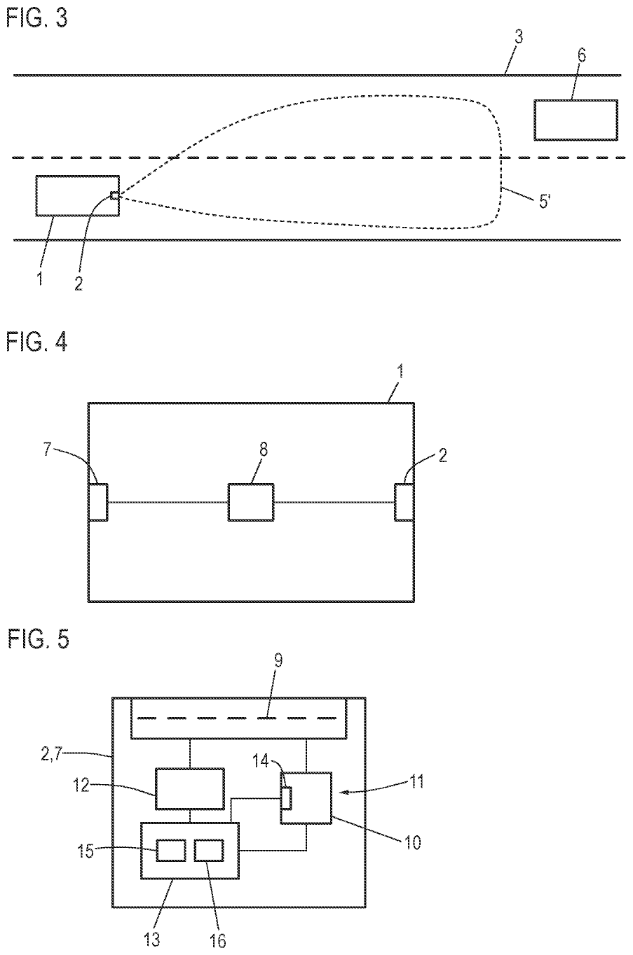

FIGS. 2 and 3 explain this in more detail using two traffic situations. FIG. 2 shows a motor vehicle 1 according to the present disclosure with a long-range front radar sensor 2 on a road 3. Another road user is approaching and is within detection range 5 of radar sensor 2. This radar sensor is operated with a transmitting power according to the first transmitting power value, so that the range is rather short. In the situation in FIG. 3, however, there is no other road user 4 and therefore no relevant object, so that the transmitting power according to the second transmitting power value is used and the detection range 5′ has a significantly increased range, for example by 50%. Thus, new relevant objects 6 indicated by way of example in FIG. 3 can be detected at an early stage.

FIG. 4 shows a schematic diagram of the motor vehicle 1 according to the present disclosure, which in the present case, in addition to the already described long-range front radar sensor 2, also comprises a long-range or medium-range rear radar sensor 7 which can forward its already pre-evaluated radar data, in particular relating to the tracking of the relevant objects, to different vehicle systems 8 that run the radar data using vehicle functions.

The functional structure of the radar sensors 2, 7 is shown in more detail in FIG. 5. Accordingly, the radar sensors 2, 7 have, in addition to an antenna arrangement 9, to which a transmission unit 11 designed as a transmission chip 10 and a receiver unit 12 are assigned, a control device 13 which is designed to carry out the method according to the present disclosure. A temperature sensor 14 is also integrated in the transmission chip 10, in this case an MMIC, and supplies its measured temperature values to the control device 13. In addition to fundamentally known functional units, the control device 13 in each case comprises a tracking unit 15 in which, as is fundamentally known, a tracking algorithm is executed. The tracking unit 15 can also classify objects as relevant or irrelevant, but this can also be done by a classification unit. Information about whether a relevant object 6 was detected or not, as well as the measured temperature values of the temperature sensor 14, are forwarded to the transmitting power unit 16 specifically carrying out the method according to the present disclosure.

1.-10. (canceled)

11. A method for operating a radar sensor in a motor vehicle, comprising:
providing a transmitting power to the radar sensor, wherein the radar sensor is a long-range radar sensor, wherein the transmitting power determines a detection range of the radar sensor, and wherein the detection range is defined by at least one of an area in front of the motor vehicle or an area behind the motor vehicle;
evaluating radar data of the radar sensor, wherein the radar data is evaluated within the radar sensor; and
detecting an object in the detection range, wherein the object is detected when a relevance criterion is met,
wherein the providing the transmitting power further comprises increasing the transmitting power from a first transmitting power value to a second transmitting power value when a switching criterion is met indicating that no objects have been detected by the radar sensor.

12. The method according to claim 11, wherein
the providing the transmitting power further comprises reducing the transmitting power from the second transmitting power value to the first transmitting power value when a reduction criterion is met.

13. The method according to claim 12, wherein
the reduction criterion comprises at least a first reduction criterion and a second reduction criterion,
the first reduction criterion checks whether the object is detected by the radar sensor,
the second reduction criterion checks at least one of whether a temperature of a transmission unit of the radar sensor exceeds a first threshold value or whether a thermal reserve value of the radar sensor falls below a second threshold value, and
the thermal reserve value is a measurement of the temperature of the transmission unit over time.

14. The method according to claim 13, wherein
the reducing the transmitting power from the second transmitting power value to the first transmitting power value further comprises reducing the transmitting power in a manner selected from continuously or step-wise when the first reduction criteria is met,
the manner is selected depending on at least one selected from a distance of the object or a relative speed of the object, and
the transmitting power is reduced such that the object is still detected by the radar sensor despite the reduction of the transmitting power.

15. The method according to claim 14, wherein
the transmitting power is reduced such that the detection range is equal to or greater than the distance of the object plus a tolerance value.

16. The method according to claim 11, wherein
the relevance criterion is selected based on the radar data evaluated for the object detected.

17. The method according to claim 11, wherein
the second transmitting power value is the first transmitting power value increased by a first percentage,
the detection range determined by the second transmitting power value is the detection range determined by the first transmitting power value increased by a second percentage,
the first percentage is between 20% and 50%, and
the second percentage is between 30% and 70%.

18. The method according to claim 17, wherein
the first percentage is 30%, and
the second percentage is 50%.

19. The method according to claim 13, wherein
the transmission unit of the radar sensor is a transmission chip.

20. The method according to claim 19, wherein
the transmission chip is an monolithic microwave integrated circuit (MMIC).

21. The method according to claim 19, wherein
the transmission chip comprises a temperature sensor that is used to measure the temperature of the transmission unit of the radar sensor.

22. A motor vehicle, comprising:
a radar sensor, wherein the radar sensor is a long-range radar sensor, and wherein the radar sensor has a detection range that is defined by at least one of an area in front of the motor vehicle or an area behind the motor vehicle; and
a control device configured to control the radar sensor to perform operations comprising:
providing a transmitting power to the radar sensor, wherein the transmitting power determines the detection range of the radar sensor;
evaluating radar data of the radar sensor, wherein the radar data is evaluated within the radar sensor; and
detecting an object in the detection range, wherein the object is detected when a relevance criterion is met,
wherein the providing the transmitting power further comprises increasing the transmitting power from a first transmitting power value to a second transmitting power value when a switching criterion is met indicating that no objects have been detected by the radar sensor.
